(19) United States
(12) Patent Application Publication
(10) Pub. No.: US 2020/0051529 A1
(43) Pub. Date: Feb. 13, 2020

(54) DISPLAY DEVICE, DISPLAY CONTROL METHOD, AND STORAGE MEDIUM

(71) Applicant: HONDA MOTOR CO., LTD., Tokyo (JP)

(72) Inventors: Masafumi Higashiyama, Wako-shi (JP); Takuya Kimura, Wako-shi (JP); Shinji Kawakami, Wako-shi (JP); Tatsuya Iwasa, Wako-shi (JP); Yuji Kuwashima, Wako-shi (JP)

(21) Appl. No.: 16/517,884

(22) Filed: Jul. 22, 2019

(30) Foreign Application Priority Data
Aug. 7, 2018 (JP) 2018-148792

(51) Int. Cl. G09G 5/37; G02B 27/01

(52) U.S. Cl. CPC G09G 5/37; G02B 27/0179; G02B 27/0101; G09G 2380/10; G02B 26/0816; G09G 2320/0626; G09G 2340/045; G09G 2340/0464; G02B 2027/0187; G09G 2354/00

(57) ABSTRACT

A display device includes an image generation device configured to cause an image to be superimposed on a landscape and viewed by a viewer, and a control device configured to control the image generation device, wherein the control device is configured to control the image generation device such that a display mode of the image is changed according to a gaze time during which the viewer gazes at the image output by the image generation device.

### CROSS-REFERENCE TO RELATED APPLICATION

Priority is claimed on Japanese Patent Application No. 2018-148792, filed Aug. 7, 2018, the content of which is incorporated herein by reference.

### BACKGROUND

### Field of the Invention

The present invention relates to a display device, a display control method, and a storage medium.

### Description of Related Art

A head up display device (hereinafter referred to as an HUD device) which displays an image regarding basic information for a driver on a front windshield is known in the related art (for example, Japanese Unexamined Patent Application, First Publication No. 2017-91115). Using this HUD device, obstacles, alerts, or various signs indicating traveling directions can be displayed overlapping the landscape in front of the vehicle, whereby the driver can identify various displayed information while maintaining the direction of his or her line of sight for driving forward.

### SUMMARY

However, in the related art, even when the driver has already identified the display content, the HUD display with the same content continues to be displayed and thus the driver may feel bothered about the HUD display.

Aspects of the present invention have been made in view of such circumstances and it is an object of the present invention to provide a display device, a display control method, and a storage medium which can improve the driver's comfort.

The display device, the display control method, and the storage medium according to the present invention adopt the following configurations.

(1) A display device according to a first aspect of the present invention is a display device including an image generation device configured to cause an image to be superimposed on a landscape and viewed by a viewer, and a control device configured to control the image generation device, wherein the control device is configured to control the image generation device such that a display mode of the image is changed according to a gaze time during which the viewer gazes at the image output by the image generation device.

(2) In the display device according to the above aspect (1), the control device is configured to detect a line of sight of the viewer and assume that the viewer is gazing at the image if the image is at a destination of the line of sight.

(3) In the display device according to the above aspect (1), the control device is configured to stop displaying the image when changing the display mode of the image.

(4) In the display device according to the above aspect (1), the control device is configured to, when the image is a first image prompting attention to a target object and the gaze time is equal to or longer than a first predetermined time, assume that the viewer has viewed the first image and change a display mode of the first image.

(5) In the display device according to the above aspect (1), the control device is configured to, when the image is a second image prompting attention to a fixed guide object and the gaze time is equal to or longer than a second predetermined time, assume that the viewer has viewed the second image and change a display mode of the second image.

(6) In the display device according to the above aspect (5), the control device is configured to change the display mode of the image to prevent the viewer from gazing at the image when the gaze time is equal to or longer than a third predetermined time which is longer than the second predetermined time.

(7) In the display device according to the above aspect (1), the image generation device includes a light projecting device configured to output the image as light, an optical mechanism provided on a path of the light and capable of adjusting a distance from a predetermined position to a position where the light is imaged as a virtual image, a concave mirror configured to reflect light that has passed through the optical mechanism toward a reflector, a first actuator configured to adjust the distance in the optical mechanism, and a second actuator configured to adjust a reflection angle of the concave mirror.

(8) A display control method according to an aspect of the present invention is a display control method for a computer configured to control an image generation device configured to cause an image to be superimposed on a landscape and viewed by a viewer, the display control method including the computer acquiring a gaze time during which the viewer gazes at the image output by the image generation device, and controlling the image generation device such that a display mode of the image is changed according to the gaze time.

(9) A storage medium according to an aspect of the present invention is a (computer-readable non-transitory) storage medium storing a program for a computer configured to control an image generation device configured to cause an image to be superimposed on a landscape and viewed by a viewer, the program causing the computer to acquire a gaze time during which the viewer gazes at the image output by the image generation device, and control the image generation device such that a display mode of the image is changed according to the gaze time.

According to the aspects (1) to (9), it is possible to improve the driver's comfort.

### BRIEF DESCRIPTION OF THE DRAWINGS

FIG. 1 is a diagram exemplifying a configuration of an occupant compartment of a vehicle M in which a display device according to an embodiment is mounted.

FIG. 2 is a diagram illustrating operation switches of an embodiment.

FIG. 3 is a partial configuration diagram of the display device.

FIG. 4 is a diagram showing an exemplary configuration of the display device centering on a display control device.

FIG. 5 is a diagram showing examples of virtual images that are displayed by the display control device.

FIG. 6 is a diagram showing other examples of virtual images that are displayed by the display control device.

FIG. 7 is a diagram showing an example of a mode of changing a virtual image.

FIG. 8 is a diagram showing another example of the mode of changing the virtual image.

FIG. 9 is a diagram showing an example of a gaze prevention mode of a virtual image.

FIG. 10 is a flowchart showing an exemplary flow of a process performed by the display device.

FIG. 11 is a diagram showing a modification of the configuration of the display device centering on the display control device.

### DETAILED DESCRIPTION OF THE INVENTION

Hereinafter, embodiments of a display device, a display control method, and a storage medium of the present invention will be described with reference to the drawings. The display device is, for example, a device which is mounted in a vehicle (hereinafter referred to as a vehicle M) and causes an image to be viewed such that it is superimposed on a landscape. The display device can be referred to as an HUD device. An example of the display device is a device which projects light including an image on a front windshield of the vehicle M to allow a viewer to view a virtual image. The viewer is, for example, a driver, but may also be an occupant other than the driver. The display device may be realized by a light transmissive display device (for example, a liquid crystal or an organic electroluminescence (EL) display) attached to the front windshield of the vehicle M. Light may also be projected on a transparent member (such as a visor or a lens of glasses) included in a device which a human being mounts on his or her body or a light transmissive display device may be attached to such a device. In the following description, it is assumed that the display device is a device which is mounted in the vehicle M and projects light including an image on the front windshield.

In the following description, positional relationships and the like will be described using an XYZ coordinate system as appropriate.

### [Overall Structure]

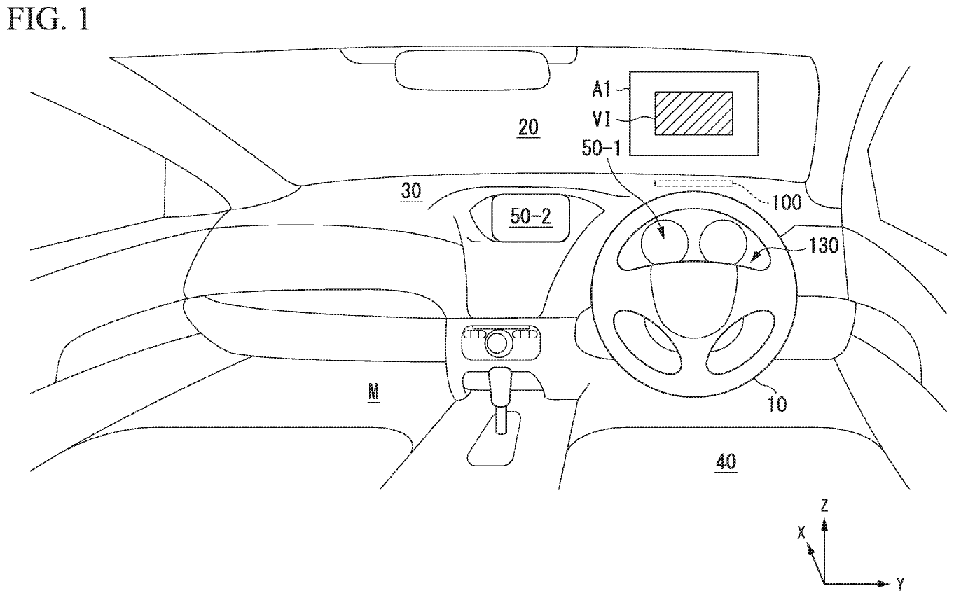

FIG. 1 is a diagram exemplifying a configuration of an occupant compartment of a vehicle M in which a display device 100 according to an embodiment is mounted. The vehicle M is provided with, for example, a steering wheel 10 for controlling the steering of the vehicle M, a front windshield (an example of the reflector) 20 that separates the occupant compartment and the outside of the vehicle from each other, and an instrument panel 30. The front windshield 20 is a light transmissive member. The display device 100 allows a driver seated on the driver's seat to view a virtual image VI, for example, by projecting (casting) light including an image on a displayable area A1 provided on a portion of the front windshield 20 in front of a driver's seat 40.

The display device 100 allows the driver to view, for example, an image obtained by imaging information for assisting the driver's driving as a virtual image VI. The information for assisting the driver's driving includes, for example, information such as the speed of the vehicle M, the driving power distribution ratio, the engine speed, the operation state shift positions of driving support functions, sign recognition results, and the positions of intersections. The driving support functions are, for example, a direction indicator function, an adaptive cruise control (ACC), a lane keep assist system (LKAS), a collision mitigation brake system (CMBS), and a traffic jam assist function.

The vehicle M may be provided with a first display device 50-1 and a second display device 50-2 in addition to the display device 100. The first display device 50-1 is, for example, a display device which is provided on the instrument panel 30 in the vicinity of the front of the driver's seat 40 and which the driver can view through a gap in the steering wheel 10 or over the steering wheel 10. The second display device 50-2 is attached to, for example, a central portion of the instrument panel 30. The second display device 50-2 displays, for example, an image corresponding to a navigation process performed by a navigation device (not shown) mounted in the vehicle M or an image of another party on a videophone. The second display device 50-2 may display television shows, play DVDs, and display content such as downloaded movies.

The vehicle M is provided with operation switches (examples of operation units) 130 that receive an instruction to switch the display of the display device 100 on/off or an instruction to adjust the position of the virtual image VI. The operation switches 130 are attached, for example, at a position where the driver seated on the driver's seat 40 can operate them without changing his or her position much. The operation switches 130 may be provided, for example, in front of the first display device 50-1 or may be provided on a boss of the steering wheel 10, or may be provided on a spoke that connects the steering wheel 10 and the instrument panel 30.

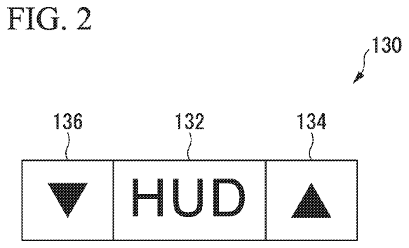

FIG. 2 is a diagram illustrating the operation switches 130 according to an embodiment. The operation switches 130 include, for example, a main switch 132 and adjustment switches 134 and 136. The main switch 132 is a switch for switching the display device 100 on/off.

The adjustment switch 134 is, for example, a switch for receiving an instruction to move the position of the virtual image VI, which is viewed from the driver's sight position P1 as being in a space after being transmitted through the displayable area A1, toward an upper side in the vertical direction Z (hereinafter referred to upward). The driver can continuously move the viewing position of the virtual image VI upward in the displayable area A1 by continuously pressing the adjustment switch 134.

The adjustment switch 136 is a switch for receiving an instruction to move the position of the virtual image VI described above toward a lower side in the vertical direction Z (hereinafter, referred to as downward). The driver can continuously move the viewing position of the virtual image VI downward in the displayable area A1 by continuously pressing the adjustment switch 136.

The adjustment switch 134 may be a switch for raising the brightness of the virtual image VI that is viewed, instead of (or in addition to) moving the position of the virtual image VI upward. The adjustment switch 136 may be a switch for lowering the brightness of the virtual image VI that is viewed, instead of (or in addition to) moving the position of the virtual image VI downward. The content of instructions received by the adjustment switches 134 and 136 may be switched based on a certain operation. The certain operation is, for example, a long press operation of the main switch 132. The operation switches 130 may include, for example, a switch for selecting the content to be displayed or a switch for adjusting only the brightness of a virtual image displayed, in addition to the switches shown in FIG. 2.

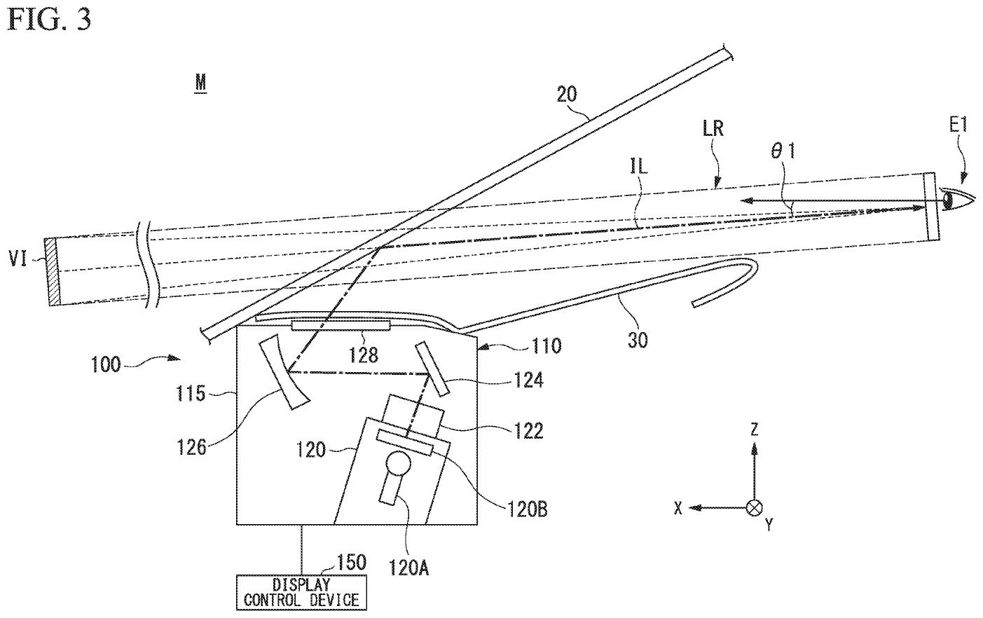

FIG. 3 is a partial configuration diagram of the display device 100. The display device 100 includes, for example, a display unit (an example of the image generation device) 110 and a display control device (an example of the control device) 150. The display unit 110 accommodates, for example, a light projecting device 120, an optical mechanism 122, a plane mirror 124, a concave mirror 126, and a light transmission cover 128 in a housing 115. The display device 100 includes various sensors and actuators, which will be described later, in addition to these components.

The light projecting device 120 includes, for example, a light source 120A and a display element 120B. The light source 120A is, for example, a cold cathode tube and outputs visible light corresponding to the virtual image VI that is to be viewed by the driver. The display element 120B controls transmission of visible light from the light source 120A. The display element 120B is, for example, a thin film transistor (TFT) type liquid crystal display (LCD). The display element 120B controls each of a plurality of pixels to control the degree of transmission of visible light from the light source 120A for each color element, whereby image elements are included in the virtual image VI and the form (appearance) of the virtual image VI is determined. Hereinafter, visible light which is transmitted through the display element 120B and thus includes an image is referred to as image light IL. The display element 120B may be an organic EL display, in which case the light source 120A may be omitted.

The optical mechanism 122 includes, for example, one or more lenses. The positions of the lenses can be adjusted, for example, in the optical axis direction. The optical mechanism 122 is provided, for example, on the path of the image light IL output from the light projecting device 120, and transmits the image light IL that is incident thereon from the light projecting device 120 and then emits the light toward the front windshield 20. For example, by changing the positions of the lenses, the optical mechanism 122 can adjust the distance from the driver's sight position P1 to a formation position P2 at which a virtual image is formed by the image light IL (hereinafter referred to as a virtual image viewing distance D). The driver's sight position P1 is a position where the image light IL is collected by being reflected by the concave mirror 126 and the front windshield 20 and where it is assumed that the driver's eyes are present. Strictly, the virtual image viewing distance D is a distance of a line segment having an inclination in the vertical direction. However, in the following description, the distance in an expression such as “the virtual image viewing distance D is 7 meters” means a horizontal distance.

In the following description, a depression angle θ1 is defined as an angle between a horizontal plane passing through the driver's sight position P1 and the line segment extending from the driver's sight position P1 to the formation position P2. The further downward the virtual image VI is formed, that is, the further downward the direction of sight in which the driver looks at the virtual image VI, the larger the depression angle θ1. The depression angle θ1 is determined based on the reflection angle φ of the concave mirror 126 and the display position of the original image on the display element 120B as will be described later. The reflection angle φ is an angle between the incident direction in which the image light IL reflected by the plane mirror 124 is incident on the concave mirror 126 and the emission direction in which the concave mirror 126 emits the image light IL.

The plane mirror 124 reflects the visible light emitted by the light source 120A and having passed through the display element 120B (that is, the image light IL) in a direction toward the concave mirror 126.

The concave mirror 126 reflects the image light IL that is incident thereon from the plane mirror 124 and emits it toward the front windshield 20. The concave mirror 126 is supported such that it is rotatable (pivotable) about a Y axis which is the axis in the lateral direction of the vehicle M.

The light transmission cover 128 transmits the image light IL from the concave mirror 126, such that the image light IL reaches the front windshield 20, while preventing the entry of foreign matter such as dust and dirt or water droplets into the housing 115. The light transmission cover 128 is provided in an opening formed in an upper member of the housing 115. The instrument panel 30 also has an opening or a light transmissive member, and the image light IL passes through the light transmission cover 128 and the opening or the light transmissive member of the instrument panel 30 and then reaches the front windshield 20.

The image light IL incident on the front windshield 20 is reflected by the front windshield 20 and collected at the driver's sight position P1. At this time, the driver feels that an image formed by the image light IL is displayed in front of the vehicle M.

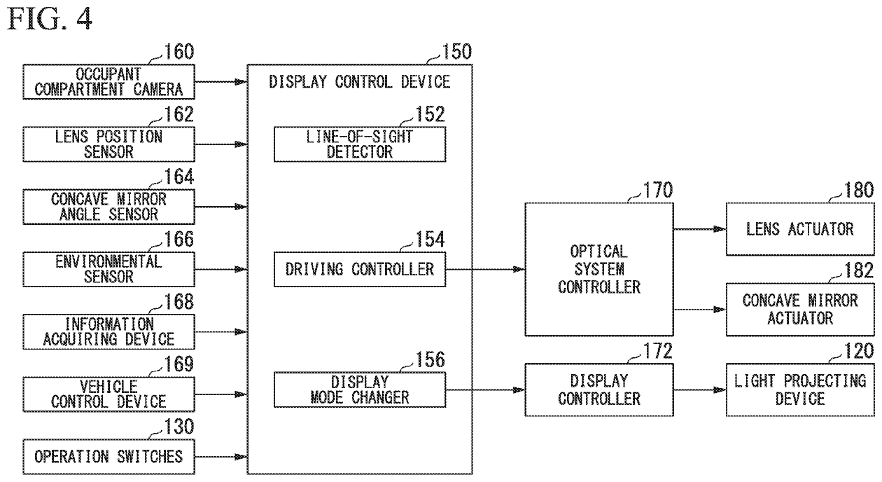

The display control device 150 controls the display of the virtual image VI that is viewed by the driver. FIG. 4 is a diagram showing an exemplary configuration of the display device 100 centering on the display control device 150. In the example of FIG. 4, a lens position sensor 162, a concave mirror angle sensor 164, an environmental sensor 166, an information acquiring device 168, a vehicle control device 169, an occupant compartment camera 160, the operation switches 130, an optical system controller 170, a display controller 172, a lens actuator (an example of the first actuator) 180, a concave mirror actuator (an example of the second actuator) 182, the light projecting device 120, which are included in the display device 100, are shown in addition to the display control device 150.

The occupant compartment camera 160 captures an image of the driver's face. The lens position sensor 162 detects the position of one or more lenses included in the optical mechanism 122. The concave mirror angle sensor 164 detects the rotational angle of the concave mirror 126 about the Y axis shown in FIG. 3. The environmental sensor 166 detects, for example, the temperature of the light projecting device 120 or the optical mechanism 122 or detects the luminance around the vehicle M.

The information acquiring device 168 acquires information on the surrounding environments of the vehicle M from a vehicle exterior camera, a radar, a LIDAR, a communication device, a navigation device, and the like. The vehicle control device 169 is, for example, an electronic control unit (ECU) (for example, an engine ECU or a steering ECU) mounted in the vehicle M and acquires the speed, the steering angle, or the like of the vehicle M on the basis of the outputs of sensors (not shown).

The display control device 150 includes, for example, a line-of-sight detector 152, a driving controller 154, and a display mode changer 156. Each of these components is realized, for example, by a hardware processor such as a central processing unit (CPU) executing a program (software). Some or all of these components may be realized by hardware (including circuitry) such as a large scale integration (LSI), an application specific integrated circuit (ASIC), a field-programmable gate array (FPGA), or a graphics processing unit (GPU) or may be realized by hardware and software in cooperation. The program may be stored in advance in a storage device (not shown) such as an HDD or a flash memory of the display control device 150 or may be stored in a detachable storage medium such as a DVD or a CD-ROM and then installed in the HDD or flash memory of the display control device 150 by inserting the storage medium into a drive device.

The line-of-sight detector 152 analyzes the image of the driver captured by the occupant compartment camera 160 and detects the direction (the destination) of the line of sight of the driver. For example, the line-of-sight detector 152 determines the driver's head region in the image captured by the occupant compartment camera 160 and specifies the driver's position. The line-of-sight detector 152 determines a representative point on the driver's head and derives a vector from the determined representative point to the position of the driver's eyes. The line-of-sight detector 152 also quantifies the direction of the driver's pupil. The line-of-sight detector 152 detects the direction of the line of sight of the driver on the basis of the derived vector and information on the quantified direction of the driver's pupil.

The line-of-sight detector 152 derives the sight point of the occupant (a point indicating a target object or location of the detected line of sight). A three-dimensional model of the space in the occupant compartment is stored in a memory, and the line-of-sight detector 152 derives the sight point by plotting the representative point and the direction of sight on the model. The line-of-sight detector 152 outputs the detection result to the display mode changer 156.

The driving controller 154 adjusts the position of the virtual image VI that is viewed by the driver, for example, according to the content of operations from the operation switches 130. For example, when an operation of the adjustment switch 134 is received, the driving controller 154 outputs a first control signal for moving the position of the virtual image VI upward in the displayable area A1 to the optical system controller 170. To move the virtual image VI upward is, for example, to decrease the depression angle θ1 between the horizontal direction defined from the driver's sight position shown in FIG. 3 and the direction in which the virtual image VI is viewed from the sight position. When an operation of the adjustment switch 136 is received, the driving controller 154 outputs a first control signal for moving the position of the virtual image VI downward in the displayable area A1 to the optical system controller 170. To move the virtual image VI downward is, for example, to increase the depression angle θ1.

The driving controller 154 outputs, for example, a second control signal for adjusting the magnification to the optical system controller 170 on the basis of the speed of the vehicle M detected by the vehicle control device 169. The driving controller 154 controls the optical mechanism 122 such that the optical mechanism 122 changes the virtual image viewing distance D in accordance with the speed of the vehicle M. For example, the driving controller 154 makes the virtual image viewing distance D larger when the speed of the vehicle M is high and makes the virtual image viewing distance D smaller when the speed is small. The driving controller 154 controls the optical mechanism 122 such that the optical mechanism 122 minimizes the virtual image viewing distance D while the vehicle M is stationary. To make the virtual image viewing distance D larger, the driving controller 154 causes the concave mirror actuator 182 to manipulate and adjust the reflection angle φ of the concave mirror 126 such that the depression angle θ1 of the virtual image VI is not changed.

The display mode changer 156 detects that the driver has viewed the display content of the virtual image VI from the movement of the line of sight of the driver detected by the line-of-sight detector 152. For example, when the destination of the line of sight of the driver continues to be in the direction of display of the virtual image VI for a predetermined time or longer, the display mode changer 156 assumes that the driver is gazing at the display content of the virtual image VI and determines that the driver has viewed the display content of the virtual image VI.

The display mode changer 156 changes the display mode of the virtual image VI according to the detection result output from the line-of-sight detector 152. The change of the display mode by the display mode changer 156 will be described later.

The optical system controller 170 drives the lens actuator 180 or the concave mirror actuator 182 on the basis of the first control signal or the second control signal received by the driving controller 154. The lens actuator 180 includes a motor or the like connected to the optical mechanism 122 and moves the position of one or more lenses in the optical mechanism 122 to adjust the virtual image viewing distance D. The concave mirror actuator 182 includes a motor or the like connected to the rotation shaft of the concave mirror 126 and adjusts the reflection angle of the concave mirror 126.

For example, the optical system controller 170 drives the lens actuator 180 on the basis of the first control signal information acquired from the driving controller 154 and drives the concave mirror actuator 182 on the basis of the second control signal information acquired from the driving controller 154.

The lens actuator 180 acquires a drive signal from the optical system controller 170 and drives a motor or the like on the basis of the acquired drive signal to move the position of one or more lenses included in the optical mechanism 122. Thereby, the virtual image viewing distance D is adjusted.

The concave mirror actuator 182 acquires a drive signal from the optical system controller 170 and drives a motor or the like on the basis of the acquired drive signal to rotate the concave mirror actuator 182 about the Y axis to adjust the reflection angle φ of the concave mirror 126. Thereby, the depression angle θ1 is adjusted.

The display controller 172 causes the light projecting device 120 to project predetermined image light IL on the basis of display control information from the display mode changer 156.

Hereinafter, a method of changing the display mode according to the line of sight of the driver by the display mode changer 156 will be described. The display mode changer 156 changes the display mode on the basis of the detection result obtained by the line-of-sight detector 152, the time during which the driver gazes at the virtual image VI, and the display characteristics of the virtual image VI.

### [Display Mode for Target Objects]

In the case where a virtual image VI displays information prompting attention to traffic participants such as other vehicles, oncoming vehicles, or pedestrians, the display mode changer 156 assumes that the driver has viewed the display content of the virtual image VI and changes the display mode of the virtual image VI, for example, when the line-of-sight detector 152 has detected that the line of sight of the driver has overlapped the display location of the virtual image VI for a first predetermined time (for example, 0.2 seconds) or longer. Changing the display mode includes, for example, changing the brightness of the virtual image VI, lightening or reducing the color or brightness of the virtual image VI, increasing the display depression angle of the virtual image VI, changing the virtual image VI to an icon of a smaller size than the virtual image VI which indicates information having the same meaning as the virtual image VI, or moving the display position of the virtual image VI. The first predetermined time for which the driver views the display content of the virtual image VI may be variable according to the driver, the driving time zone, the road conditions, the weather, or the like. Traffic participants such as other vehicles, oncoming vehicles, or pedestrians are examples of “target objects.”

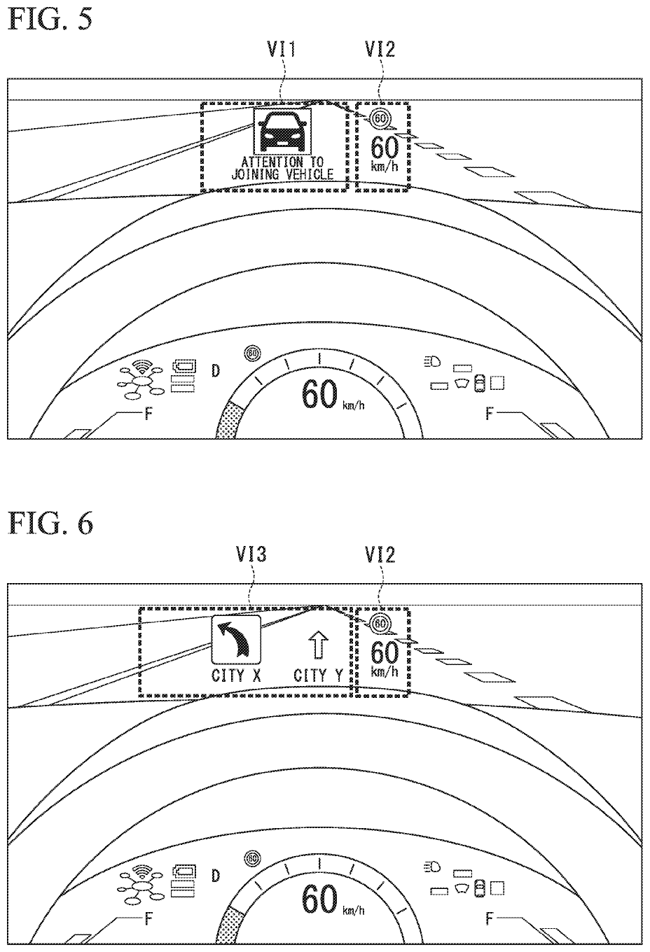

FIG. 5 is a diagram showing examples of virtual images VI that are displayed by the display control device 150. For example, when the information acquiring device 168 has detected that another vehicle is about to join the same lane as the vehicle M, the display control device 150 displays a virtual image VI1 prompting attention to the other vehicle in the displayable area A1. At this time, the display control device 150 may display information with a smaller amount of conversion than the virtual image VI1 (for example, information such as the legal speed of the road which is currently traveling on or the weather around the vehicle M) as a virtual image VI2 together with the virtual image VIE The virtual image VI1 of FIG. 5 is an example of the “first image.”

The line-of-sight detector 152 assumes that the driver has viewed the display content of the virtual image VI1 upon detecting that the line of sight of the driver has stayed in the direction of the virtual image VI1 for a predetermined time or longer or upon detecting that the line of sight of the driver passes through the outline of the virtual image VI1 or the locus of display of letters. For example, the line-of-sight detector 152 assumes that the driver has viewed the virtual image VI1 when the line of sight of the driver is concentrated on an arrow portion of the virtual image VI1 of FIG. 5 or when the line of sight of the driver has followed letters in the virtual image VI1 of FIG. 5 “ATTENTION TO JOINING VEHICLE” in the same order as that in which the letters are arranged. The line-of-sight detector 152 outputs the detection result to the display mode changer 156.

### [Display Mode for Fixed Guide Objects]

In the case where display content such as a road sign or a guide plate is excerpted and a virtual image VI displays information prompting the driver's attention by displaying the excerpted display content, the display mode changer 156 assumes that the driver has viewed the display content of the virtual image VI and changes the display mode of the virtual image VI, for example, when the line-of-sight detector 152 has detected that the line of sight of the driver has overlapped the display location of the virtual image VI for a second predetermined time (for example, about 0.3 to 0.5 seconds for each piece of information) or longer. The second predetermined time for which the driver views the display content of the virtual image VI may be variable according to the driver, the driving time zone, the weather, or the like. The road sign or guide plate is an example of the “fixed guide object.”

FIG. 6 is a diagram showing other examples of virtual images VI that are displayed by the display control device 150. For example, when the information acquiring device 168 has detected that the vehicle M is scheduled to approach a crossroads, the display control device 150 displays a virtual image VI3 including the distance to the crossroads and information indicated on a guide plate in the displayable area A1. The virtual image VI3 of FIG. 6 is an example of the “second image.”

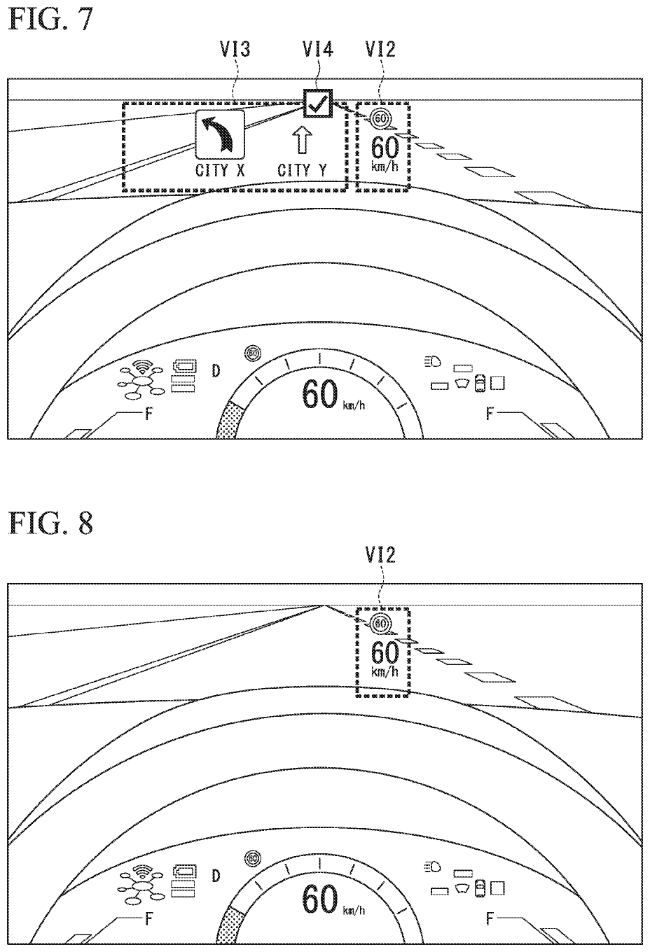

FIGS. 7 and 8 are diagrams showing examples of a mode of changing the virtual image VI3. The display mode changer 156 may notify the driver that processing will be performed assuming that the driver has viewed the virtual image VI3, by displaying a virtual image VI4 of a check box in an animated fashion at a position near the virtual image VI3 as shown in FIG. 7. After displaying the virtual image VI4, the display mode changer 156 may stop displaying the virtual images VI3 and VI4 as shown in FIG. 8.

If the line-of-sight detector 152 detects that the driver has gazed again at the virtual image VI3 even when the display mode changer 156 has notified the driver using the virtual image VI4 that processing will be performed assuming that the driver has viewed the virtual image VI3, the display mode changer 156 assumes that the driver has expressed his or her desire that the virtual image VI3 be displayed as it was and stops changing the display mode.

The display mode changer 156 may stop changing the display mode of the virtual image VI when a specific motion of the driver (for example, a specific gesture) is detected through the occupant compartment camera 160. The display mode changer 156 may also stop changing the display mode of the virtual image VI when speech input by the driver is detected through the information acquiring device 168.

### [Display Gaze Prevention]

When it is detected that the line of sight of the driver has stayed in the direction of the virtual image VI for a third predetermined time (for example, about 2.5 to 5 seconds) or longer, the line-of-sight detector 152 detects that the driver is in a forward inattentive state and thus in an undesirable state and outputs an instruction to change to a gaze prevention state, which is a display prompting the driver to concentrate on driving of the vehicle M, to the display mode changer 156.

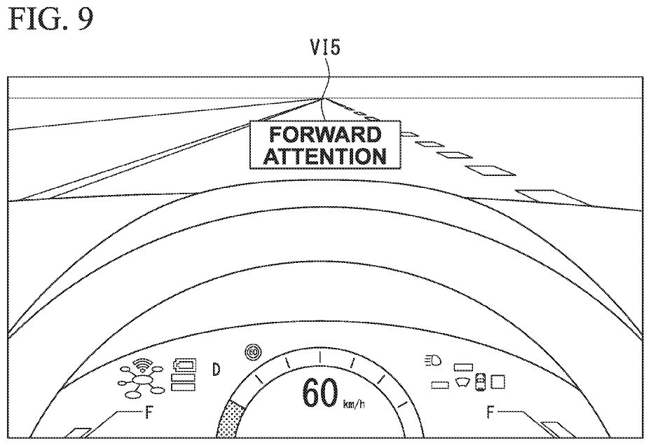

FIG. 9 is a diagram showing an example of the gaze prevention mode of the virtual image VI. For example, the display mode changer 156 displays a virtual image VI5, which is a message prompting the driver to pay attention forward, for a predetermined time and stops displaying the virtual image as shown in FIG. 9. At this time, the display mode changer 156 may or may not stop displaying the virtual image VI2 indicating information with a small amount of conversion.

After stopping displaying the virtual image VI2, the display mode changer 156 may resume displaying the virtual image VI2 when the line-of-sight detector 152 has detected that the line of sight of the driver has returned to a forward attentive state after the display of the gaze prevention mode. If no change is detected in the line of sight of the driver even after the display of the gaze prevention mode is started, the driver's poor physical condition or the like is assumed. Thus, in this case, the display mode changer 156 may coordinate the processing with the drive control mechanism of the vehicle M such that it performs driving control such as that of emergency stop of the vehicle M on the side of the road.

### [Process Flow]

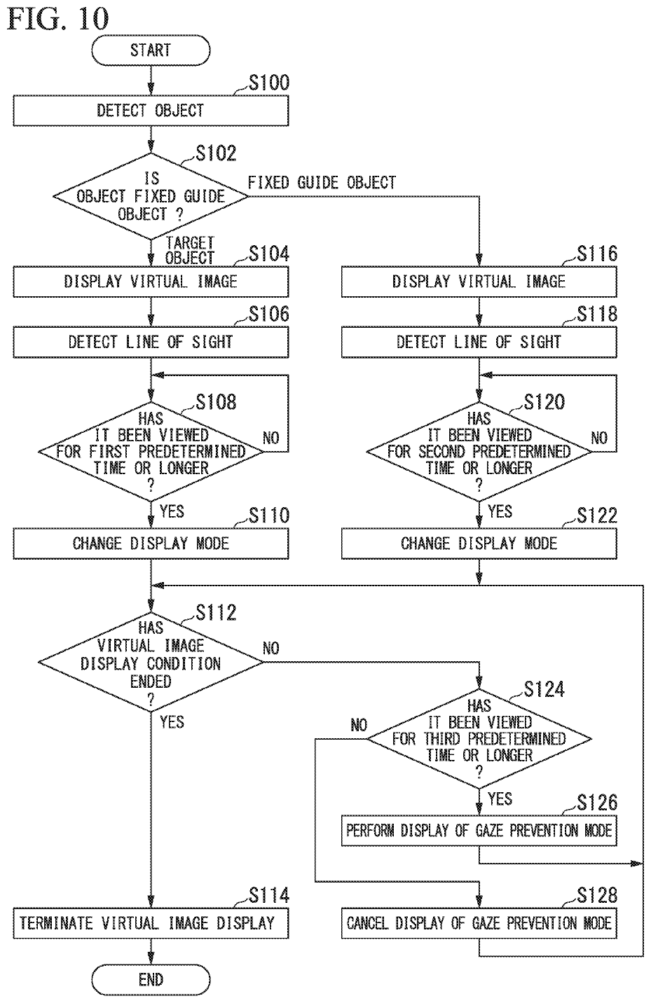

FIG. 10 is a flowchart showing an exemplary flow of a process executed by the display device 100. First, the information acquiring device 168 detects an object (a target object or a fixed guide object) that satisfies a display start condition of the virtual image VI (step S100). Next, the display control device 150 determines whether the object is a target object or a fixed guide object (step S102). Upon determining that the object is a target object, the display control device 150 starts displaying a virtual image VI (step S104).

Next, the line-of-sight detector 152 detects the line of sight of the driver (step S106). Next, the line-of-sight detector 152 determines whether or not the line of sight of the driver has stayed in the direction of the virtual image VI for a first predetermined time or longer (step S108). Upon determining that the line of sight has not stayed in the direction of the virtual image VI for the first predetermined time or longer, the line-of-sight detector 152 performs the process of step S108 again after a predetermined time has elapsed. Upon determining that the line of sight has stayed for the first predetermined time or longer, the line-of-sight detector 152 causes the display mode changer 156 to change the display mode of the virtual image VI (step S110).

Upon determining in the process of step S102 that the object is a fixed guide object, the display control device 150 starts displaying a virtual image VI (step S116). Next, the line-of-sight detector 152 detects the line of sight of the driver (step S118). Next, the line-of-sight detector 152 determines whether or not the line of sight of the driver has stayed in the direction of the virtual image VI for a second predetermined time or longer (step S120). Upon determining that the line-of-sight detector 152 has not stayed for the second predetermined time or longer, the line-of-sight detector 152 performs the process of step S120 again after a predetermined time has elapsed. Upon determining that the line of sight has stayed for the second predetermined time or longer, the line-of-sight detector 152 causes the display mode changer 156 to change the display mode of the virtual image VI (step S122).

After the process of step S110 or step S122, the display mode changer 156 determines whether or not the display condition of the virtual image VI has ended (step S112). Upon determining that the display condition has ended, the display mode changer 156 terminates the display of the virtual image VI (step S114). Upon determining that the display condition has not ended, the display mode changer 156 causes the line-of-sight detector 152 to determine whether or not the virtual image VI has been viewed for a third predetermined time or longer (step S124). If it is determined that the virtual image VI has been viewed for the third predetermined time or longer, the display mode changer 156 changes the virtual image VI to a gaze prevention mode (step S126) and returns the process to step S112. If it is determined in the process of step S124 that the virtual image VI has not been viewed for the third predetermined time or longer, the display mode changer 156 cancels the change of the virtual image VI to the gaze prevention mode (step S128) and returns the process to step S112. This is the end of the description of the process of this flowchart.

### [Learning of Line of Sight]

The line-of-sight detector 152 may learn the tendency of the line of sight of the driver and the tendency of the viewing time. When the line-of-sight detector 152 has determined that the line of sight of the driver is not directed to the displayable area A1 of the virtual image VI for a predetermined time or longer, this can be considered as cases such as where the driver intentionally neglects information on the virtual image VI or where there is an error in the detection method of the line of sight by the line-of-sight detector 152. The line-of-sight detector 152 improves the detection accuracy of the line of sight of the driver by learning such situations as needed. For example, information identical or similar to the virtual image VI is not displayed on the display device 100 when the line-of-sight detector 152 cannot detect the line of sight of the driver and it is determined from the learning result that the driver has intentionally ignored the information of the virtual image VI.

### [Modification]

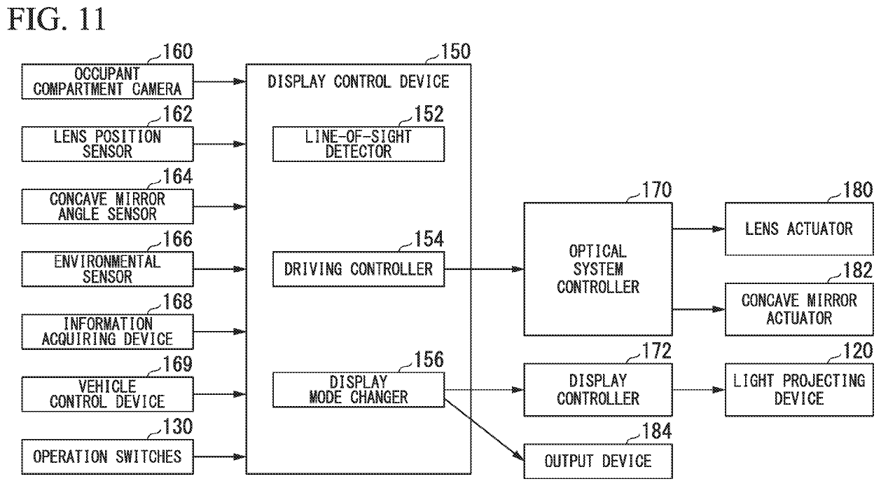

FIG. 11 is a diagram showing a modification of the configuration of the display device 100 centering on the display control device 150. For example, the display device 100 may cooperate with an output device 184 to output a sound prompting the driver's attention or a display unit of another output device 184 may cooperate with the display device 100 to display the same as that of the display device 100. The output device 184 is, for example, a navigation device. The output device 184 may be either the first display device 50-1 or the second display device 50-2.

### [Other HUD Display Area]

Instead of projecting an image directly on the front windshield 20, the display device 100 may project an image on a light transmissive reflective member such as a combiner provided between the front windshield 20 and the position of the driver.

As described above, the display control device 150 in the display device 100 includes the display unit 110 configured to cause an image to be superimposed on a landscape and viewed by a viewer such as the driver and the display control device 150 configured to control the image generation device. Through both the line-of-sight detector 152 configured to detect the sight point of an occupant such as the driver who is the viewer of a virtual image VI output by the display unit 110 and the display mode changer 156 configured to control the display unit 110 such that the display mode of the virtual image VI is changed according to the gaze time of the viewer detected by the line-of-sight detector 152, the display control device 150 can change the display mode of the virtual image VI already viewed by the occupant and thus can improve the driver's comfort.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A display device comprising:
an image generation device configured to cause an image to be superimposed on a landscape and viewed by a viewer; and
a control device configured to control the image generation device,
wherein the control device is configured to control the image generation device such that a display mode of the image is changed according to a gaze time during which the viewer gazes at the image output by the image generation device.

2. The display device according to claim 1, wherein the control device is configured to detect a line of sight of the viewer and assume that the viewer is gazing at the image if the image is at a destination of the line of sight.

3. The display device according to claim 1, wherein the control device is configured to stop displaying the image when changing the display mode of the image.

4. The display device according to claim 1, wherein the control device is configured to, when the image is a first image prompting attention to a target object and the gaze time is equal to or longer than a first predetermined time, assume that the viewer has viewed the first image and change a display mode of the first image.

5. The display device according to claim 1, wherein the control device is configured to, when the image is a second image prompting attention to a fixed guide object and the gaze time is equal to or longer than a second predetermined time, assume that the viewer has viewed the second image and change a display mode of the second image.

6. The display device according to claim 5, wherein the control device is configured to change the display mode of the image to prevent the viewer from gazing at the image when the gaze time is equal to or longer than a third predetermined time which is longer than the second predetermined time.

7. The display device according to claim 1, wherein the image generation device includes:
a light projecting device configured to output the image as light;
an optical mechanism provided on a path of the light and capable of adjusting a distance from a predetermined position to a position where the light is imaged as a virtual image;
a concave mirror configured to reflect light that has passed through the optical mechanism toward a reflector;
a first actuator configured to adjust the distance in the optical mechanism; and
a second actuator configured to adjust a reflection angle of the concave mirror.

8. A display control method for a computer configured to control an image generation device configured to cause an image to be superimposed on a landscape and viewed by a viewer, the display control method comprising:
the computer acquiring a gaze time during which the viewer gazes at the image output by the image generation device; and
controlling the image generation device such that a display mode of the image is changed according to the gaze time.

9. A computer-readable non-transitory storage medium storing a program for a computer configured to control an image generation device configured to cause an image to be superimposed on a landscape and viewed by a viewer, the program causing the computer to:
acquire a gaze time during which the viewer gazes at the image output by the image generation device; and
control the image generation device such that a display mode of the image is changed according to the gaze time.
